(19) United States
(12) Patent Application Publication
(10) Pub. No.: US 2005/0008738 A1
(43) Pub. Date: Jan. 13, 2005

(54) Spiral sliced ham oven ready package and method

(76) Inventor: Lacey Lanier Tarver, North Charleston, SC (US)

Correspondence Address: RALPH BAILEY, P.A., 125 Broadus Avenue, Greenville, SC, 29601, US

(21) Appl. No.: 10/615,198

(22) Filed: Jul. 8, 2003

(51) Int. Cl. C12C 1/027

(52) U.S. Cl. 426/129

(57) ABSTRACT

A pre-sliced and pre-cooked ham (A) has seasonings (B) applied thereto and placed within a browning bag (C) preparatory to applying display wrappers (D) and any other attachments for presenting the ham in an attractive package at a meat counter so that the ham may be placed directly into the oven after removal of decorative wrappers and attachments for further home cooking in the browning bag.

### BACKGROUND OF THE INVENTION

This invention relates to a ready to cook Spiral Sliced Ham suitably packaged for presenting the ham to a customer so that the ham is prepackaged for further cooking and to a method of packaging and to a method of cooking.

Spiral sliced hams are routinely presented at meat counters to customers in vacuum sealed plastic wraps with suitable labeling and cooking instructions. The hams must then be removed from the wraps in which they have been presented and then prepared for further cooking at the customer's home. This process involves placing a ham for glazing or otherwise seasoning the ham in preparation for final cooking in a suitable utensil. The various steps in removing the ham from the package and preparation for final cooking is messy, tedious and involves assembling the necessary seasonings before finally seasoning and cooking the ham.

Suitable apparatus and methods of pre-cooking and slicing hams are available to producers use prior to packaging the ham for presentation to the customers in shrink wrap for removal and further cooking in customers' ovens.

It has been found that pre-sliced hams tend to dry out and lose flavor when thus prepared for final home cooking because surface areas found on the individual slices are especially susceptible to losing juices and flavor.

The prior art is further illustrated by U.S. Pat. No. 5,989,607 and is further illustrated by U.S. Pat. Nos. 4,820,536, 4,879,124, 4,948,610, 5,002,782, 5,002,782, 5,086,924, 5,086,924, 5,843,502, 6,196,960.

### SUMMARY OF THE INVENTION

Accordingly, it an important object of this invention to provide a spiral sliced ham for attractive presentation to customers already packaged for further home cooking.

Another important object of the invention is to provide a more flavorful juicier sliced ham product by cooking the ham at the customer's home in a browning bag provided as part of the display package.

Because the ham is pre-sliced and pre-glazed, further cooking may be accomplished in the browning bag in such a way as to utilize pre-seasoning with out loss of flavor as a result from applying seasoning after removing the ham from a shrink wrap package preparatory to further cooking. The most important advantage of the invention is convenience in home preparation and increased flavor resulting from cooking in the presentation bag.

It has been found that additional cooking should occur in a pre-heated oven to about 225° Fahrenheit. After removing the foil and other appendages used in presenting the pre-packaged ham to customers, the ham should be cooked for approximately one and one-half (1½) hours.

### BRIEF DESCRIPTION OF THE DRAWINGS

The construction designed to carry out the invention will hereinafter described, together with other features thereof.

The invention will be more readily understood from a reading of the following specification and by reference to the accompanying drawings forming a part thereof, wherein an example of the invention is shown and wherein:

FIG. 1 is a right front perspective view illustrating a spiral sliced ham product packaged in a shrink wrap for sale in accordance with the prior art.

FIG. 2 is a block diagram illustrating the various steps in packaging a pre-sliced ham in accordance with the present invention.

FIG. 3 is a stage drawing illustrating the various steps in the packaging of a pre-cooked sliced ham preparatory to sales presentation to customer for further cooking in the wrap in which it is packaged for display.

FIG. 4 is a right front perspective view illustrating a pre-cooked and pre-sliced ham product that has been vacuum-packed in a browning bag and to which a foil wrapper and netting with various appendages is ready for presentation to purchasing public.

FIG. 5 illustrates a further step in preparing the ham package for pre-cooking including the application of the browning bag and net for display and cooking purposes.

FIG. 6 is a right front perspective view illustrating the placement of a pre-seasoned, pre-sliced ham contained within a browning bag package preparatory for further cooking; and

FIG. 7 illustrates the spiral ham product having been cooked in the browning bag in accordance with the invention, removal from the browning bag and ready for serving on a platter.

### DESCRIPTION OF A PREFERRED EMBODIMENT

The drawings illustrate a meat product package and method for use directly by customers including a pre-cooked spiral sliced ham A. Seasonings B are placed on the ham forming a pre-seasoned ham already prepared for home cooking. An oven browning bag C contains the pre-cooked and pre-seasoned spiral sliced ham. Display wrappers D with attachments are provided for presenting the ham at meat counters in packages having desirable decorative and utilitarian characteristics. Thus, consumers may place the oven browning bag containing the pre-cooked spiral sliced ham directly into the oven after removal of decorative wrappers and informational and utilitarian attachments if any from the package.

The various steps in preparing the pre-cooked spiral sliced ham A include the procurement of a ham weighing from 17 to 18 pounds trimmed of undesirable fat and being skinned. The ham is then injected with the honey cure and is naturally smoked in a smokehouse on a relatively long cooking cycle. The pre-cooked ham is then spiral sliced on a suitable slicer and coated with a glaze of any desirable flavor such as maple or honey glaze mix. The pre-seasoned product is then placed into a cooking bag and vacuumed for further packaging for presentation to the public. A suitable browning bag CN-530 by Cryovac of Duncan, S.C., constructed of a non-adhesion material utilized for cook-and-ship packaging of oven-prepared turkey breast, whole birds, corned beef, and beef has been found to produce satisfactory results. It also can be used for packaging consumer-ready microwavable products. Because this bag is shrinkable and withstands high cooking temperatures, about 200° F., it has also been used for postpasteurization of precooked product.

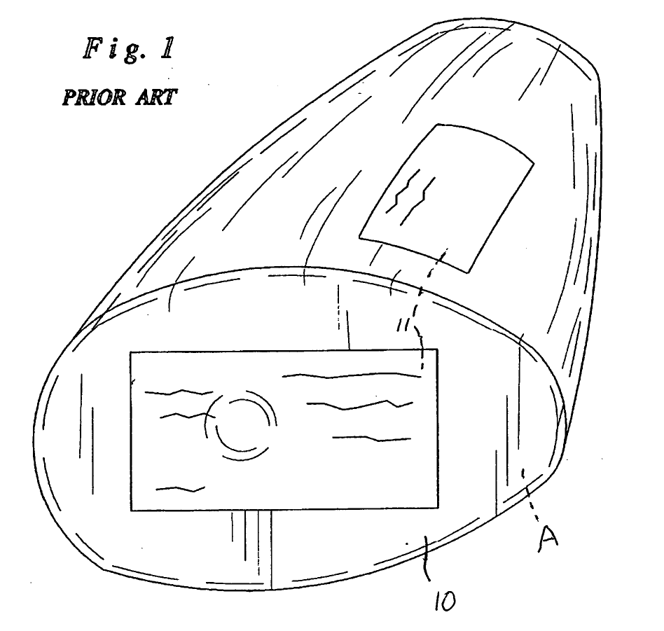

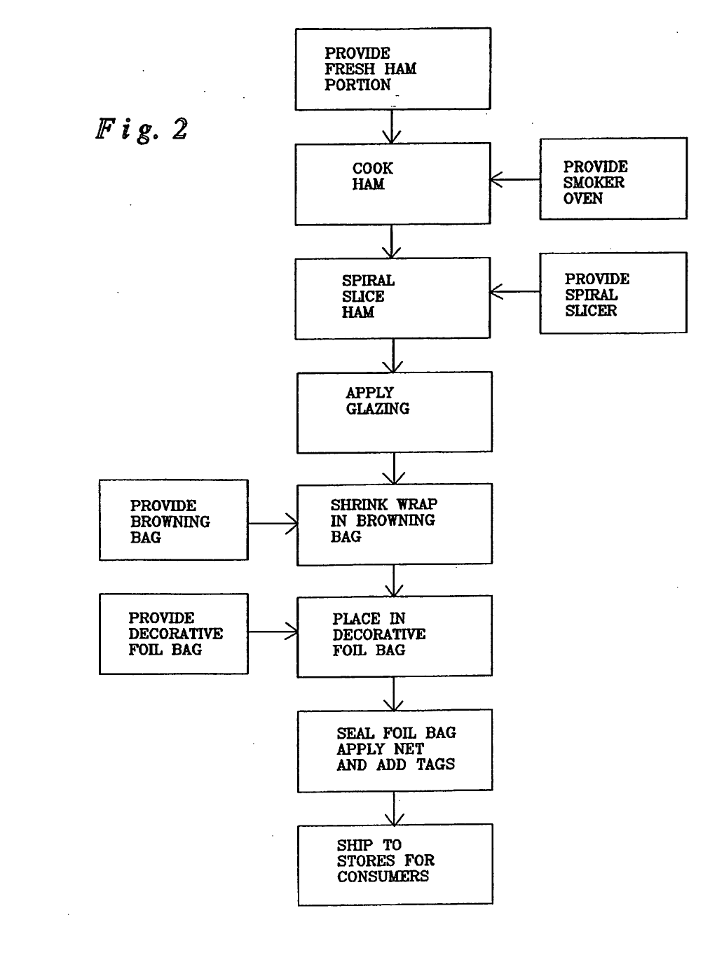

FIG. 1 illustrates a pre-cooked spiral ham contained in a shrink wrap package 10 to which various labels and cooking instructions 1k have been applied. FIG. 2 is a diagram illustrating the various steps discussed above stating in detail the various steps required in processing a sliced ham product preparatory to presentation and use by a customer.

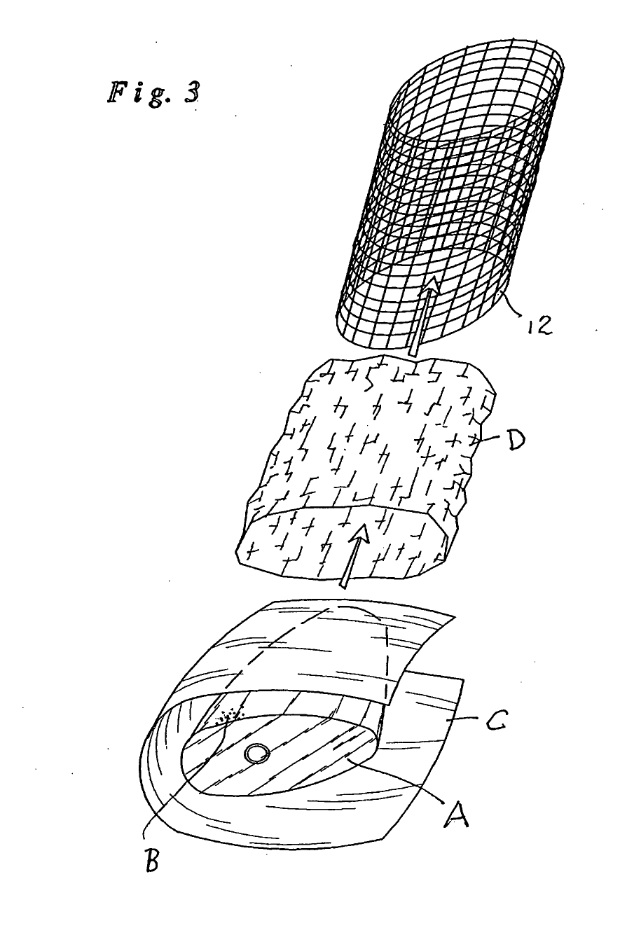

FIG. 3 illustrates the application of seasonings B preparatory to placement in a browning bag C. The foil such as a suitable gold or red decorative wrap then applied together with the usual netting 12.

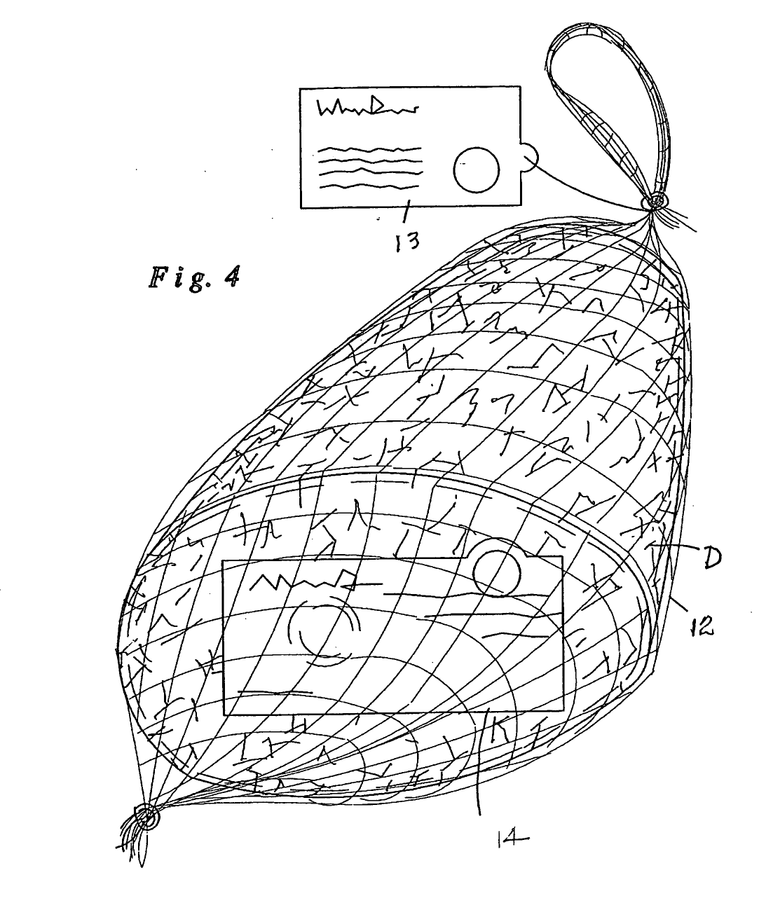

FIG. 4 illustrates the packaged product carrying the netting 12 and bags 13 containing cooking instructions together with product description and the like.

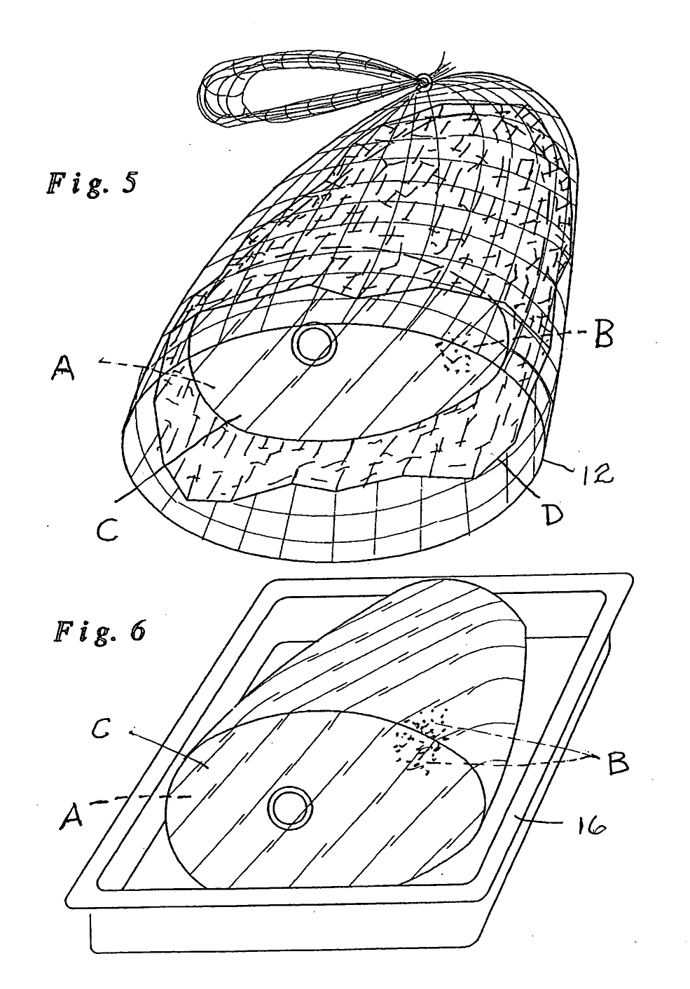

FIG. 5 illustrates the steps of preparing the ham for home cooking wherein the pre-sliced ham A has seasonings B applied thereto and vacuum packaged within a suitable browning bag C. The foil wrapper D and netting 12 is illustrated as being removed preparatory to placing the ham packaged within the browning bag within a suitable pan 16 for further cooking. The ham is within the browning bag is placed in a pre-heated oven at a temperature of about 225° F. The net and foil and attachments are removed from the ham being careful not to puncture or remove the ham from the bag. The ham is then placed on an oven rack in a roasting pan to which water has been added to protect the pan. The pan is then preferably placed in the center of the oven for cooking for about one and one-half (1½) hours.

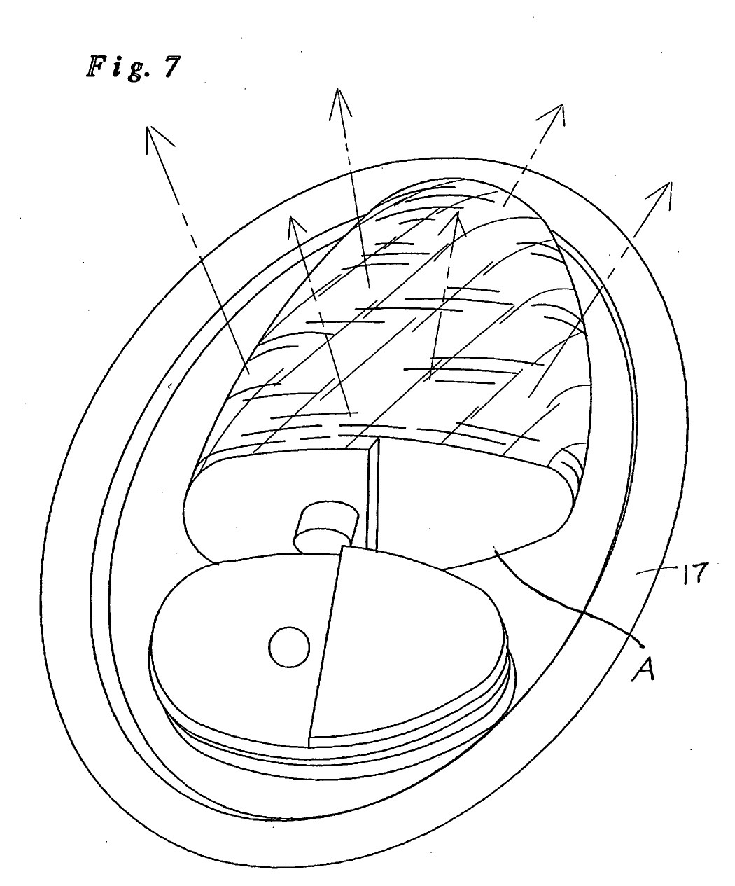

FIG. 6 illustrates the step of removing the ham from the browning bag preparatory to placing the ham upon a platter 17 as illustrated in FIG. 7 for serving.

While a preferred embodiment of the invention has been described using specific terms, such description is for illustrative purposes only, and it is to be understood that changes and variations in product and pre-packaging for home cooking may be made without departing from the spirit or scope of the following claims.

1. A meat product packaged for sale directly to customers for use without further preparation and packaging comprising:
a pre-cooked spiral sliced ham;
seasonings placed on the sliced ham forming a pre-seasoned ham already prepared for home cooking;
an oven browning bag containing the pre-cooked and pre-seasoned spiral sliced ham; and
display wrappers with informational attachments are provided for presenting the ham at meat counters in a package having desirable decorative and utilitarian characteristics;
whereby consumers may place the oven browning bag containing the pre-cooked spiral sliced ham directly into the oven for further cooking after removal of any wrappers and attachments form the package.

2. A meat product packaged for sale as set forth in claim 1 wherein the browning bag is constructed of a non-adhesion shrinkable material.

3. A meat product packaged for sale as set forth in claim 2 wherein said shrinkable material is capable of withstanding cooking temperatures of in excess of about 200° F.

4. A meat product packaged for sale as set forth in claim 3 wherein cooking temperatures of about 225° F. may be applied for the further cooking.

5. A meat product packaged for sale as set forth in claim 1 wherein said seasonings include a glaze.

6. A meat product packaged for sale to customers comprising:
a pre-cooked spiral sliced ham;
seasonings including a glaze placed on the sliced ham forming a pre-seasoned ham already prepared for home cooking; and
an oven browning bag containing the pre-cooked and pre-seasoned spiral sliced ham;
whereby consumers may place the oven browning bag containing the pre-cooked sliced ham directly into the oven for further cooking.

7. A meat product packaged for sale as set forth in claim 6 wherein said sliced ham is a spiral sliced ham.

8. A meat product packaged for sale to customers comprising:
a pre-cooked spiral sliced ham;
seasonings placed on the sliced ham forming a pre-seasoned product for home cooking; and
an oven browning bag capable of withstanding cooking temperatures in excess of about 200° F. containing the pre-cooked and pre-seasoned spiral sliced ham;
whereby consumers may place the oven browning bag containing the pre-cooked spiral sliced ham directly into the oven after removal of wrappers if any for the package for further cooking.

9. A meat product packaged for sale as set forth in claim 8 wherein the browning bag is constructed of shrinkable not stick plastic material.

10. A method of packaging and presenting a ham to a customer at a meat counter comprising the steps of:
pre-cooking and pre-slicing the ham;
placing a suitable glazing or seasoning product on the ham for pre-treatment preparatory to further cooking;
placing the pre-cooked and pre-sliced, pre-treated prepared ham in a vacuum packed plastic browning bag suitable for further cooking at customer's home in a plastic browning bag forming a packaged ham product ready for home cooking; and
applying decorative and informational material to the packaged ham so that the customer may remove the decorative material and place the packaged ham product in a suitable utensil for further cooking preparatory to serving.

11. The method of packaging and presenting a ham to a customer set forth in claim 10 including the steps of:
injecting the ham with a curing and flavoring material;
smoking the ham in a smokehouse; and
applying a glaze mix to the ham preparatory placing the ham in a browning bag.

12. A method of packaging and presenting a ham to a customer at a meat counter comprising the steps of:
pre-cooking and pre-slicing the ham;
placing a suitable glazing or seasoning product on the ham for pre-treatment preparatory to further cooking;
placing the pre-cooked and pre-sliced pre-treated prepared ham in plastic browning bag and vacuuming the bag for further cooking at a customer's home in its plastic browning bag forming a packaged ham product ready for home cooking; and
applying decorative material to the packaged ham;
whereby the customer may remove the decorative material and the packaged ham product in a suitable utensil for further cooking preparatory to serving.

13. The method of packaging and presenting a ham including utilizing a spiral sliced ham, and applying a glaze mix to the ham prior to packaging in the browning bag.

14. The method of packaging and presenting a ham including applying foil appendages and net thereover.

15. A method of cooking a spiral sliced ham comprising the steps of:
pre-packaging a cooked and seasoned spiral sliced ham in a browning bag constructed of shrinkable non adhesion materials for customer presentation;
applying decorative foil to the browning bag;
removing any decorative foil and the like; and
then placing the ham with in the browning bag within the oven for further cooking.

16. The method of cooking set forth in claim 15 wherein cooking proceeds at a temperature of about 225° F. for about one and one-half hours.

17. The method of cooking set forth in claim 16 including the step of removing the ham from the browning bag and placing the ham upon a platter for serving.
